(19) United States
(12) Patent Application Publication
(10) Pub. No.: US 2009/0178446 A1
(43) Pub. Date: Jul. 16, 2009

(54) LOCK DEVICE

(76) Inventor: Ian Patterson, Queensland (AU)

Correspondence Address: ANGUS C. FOX, III, 4093 N. IMPERIAL WAY, PROVO, UT, 84604-5386, US

(21) Appl. No.: 12/160,094

(22) PCT Filed: Dec. 27, 2006
(86) PCT No.: PCT/AU06/01953

§ 371 Date: Dec. 8, 2008

(30) Foreign Application Priority Data
Jan. 3, 2006 (AU) 2006900009

(51) Int. Cl. B60R 25/00; B62H 5/16

(52) U.S. Cl. 70/259

(57) ABSTRACT

A lock is disclosed to clamp a wheel of a motor vehicle or motor cycle to prevent its theft once parked. The locking device comprises a housing (1) having a base (2), a front face (3), an opposing rear face (4), two opposing side faces (5,6) and a hinged lid (7) to cover the internals of the housing (1). Pivoting arcuate arms (10,15) extend from the housing (1), A linkage comprises three links (20,21,22) extending between the arms (10,15). The wheel (41) of a vehicle is pushed against the linkage (20,21,22) causing the arms (10, 15) to assume a closed position flanking the rim of the wheel (41). A locking mechanism (39) is then turned to the locked position and the key removed thus preventing movement of the arms (10,15) to any open position. To release the wheel (41), the locking mechanism (39) is first unlocked and the wheel (41) then moved in a direction away from the front face (3), the arms (10,15) being moved by the wheel (41) in an outwards direction.

### FIELD OF THE INVENTION

This invention relates to locks. In particular, it is directed to a lock which finds especial, but not limiting, use as a lock for a motor vehicle or motor cycle.

### BACKGROUND OF THE INVENTION

Unfortunately, theft of motorised transport is a fact of modern society. Theft of motor cycles is. a particular concern as the recovery of stolen cycles is significantly lower than motor vehicles. Authorities have suggested that the portability of a motor cycle, the ease of mixing and matching of its parts and the greater potential to use motor cycles without registration contribute to this higher theft rate. There is thus a market for devices which eliminate, or at least greatly reduce, the likelihood of theft of such transport.

When the transport is a motor vehicle or motor cycle, prior art anti-theft devices usually provide some form of mechanical lock for one or more wheels of the vehicle or cycle. For motor cycles, such locks include chains or rods that pass through the spokes of the cycle wheel and which are then secured to, as examples, (a) a fixed point such as a post or ring set in the ground or (b) to the frame of the actual cycle,

A disadvantage of these prior art devices is that they are often cumbersome to operate and/or require the carrying of the chains or rods by the rider of the motor cycle which, at best, is inconvenient and, often, impractical.

It is thus a general object to overcome, or at least ameliorate, one or more of the above disadvantages.

### SUMMARY OF THE INVENTION

According to the present invention, there is provided a locking device for a vehicle that has at least one ground-engaging wheel, said device including:

a housing;

a first arm having one end pivotally connected within said housing and its opposing other end extending from said housing, said first arm adapted to pivot between a first open position and a second locked position;

a second arm substantially opposed to said first arm and having one end pivotally connected within said housing and its opposing other end extending from said housing, said second arm adapted to pivot between a first open position and a second locked position; and

a linkage external to said housing and pivotally connected between said first arm and said second arm;

wherein said first arm, said second arm and said linkage are adapted such that, upon sufficient forcible contact of said wheel with said linkage in a first direction substantially towards said housing, said first arm and said second arm can pivot from respective said first open position to respective said second locked position to flank and secure said wheel;

and wherein, upon subsequent sufficient forcible contact of said wheel at or near respective said other end of said first arm and/or said second arm in a second direction substantially opposed to said first direction, said first arm and said second arm can pivot from respective said second closed position to respective said first open position to release said wheel.

Preferably, said device further includes a keyed locking mechanism to prevent said release of said wheel when secured by said first arm and said second arm by movement of said wheel in said second direction.

Preferably, said locking mechanism is contained within said housing.

Preferably, said housing is adapted to prevent unauthorised access to components therein.

Preferably, said first arm and said second arm are each substantially arcuate in shape at or near said other end,

Preferably, said linkage comprises a central link pivotally connected at each end to a respective outer link, the respective other end of each respective outer link being pivotally connected to respective said first arm and said second arm.

Preferably, said one end of said first arm and said one end of said second arm are connected together by a series of pivotable links.

Preferably, said device includes a stop within said housing to assist in locating said first arm and said second arm in said first open position.

Preferably, said device includes a spring connected to one of said series of pivotable links to assist in locating said first arm and said second arm in said first open position.

Preferably, said device is permanently secured to the ground.

Optionally, two or more of said device can be deployed, either as separate or integrated units, In one such option, when two of said device are used, they can find especial use to lock both wheels of a motor cycle or the two front or two rear wheels (or one of each) of a motor vehicle.

### BRIEF DESCRIPTION OF THE DRAWINGS

FIG. 1 is a top plan view of a locking device constructed in accordance with the present invention in an open position with the lid of the housing removed;

FIG. 2 is a perspective illustration of the device of FIG. 1 with the lid affixed and in a closed position;

FIG. 3 is a top plan view of the device of FIG. 1, with the lid of the housing removed, in a closed position securing a wheel;

FIG. 4 is a perspective illustration of the device of FIG. 2 with the lid in an open position; and

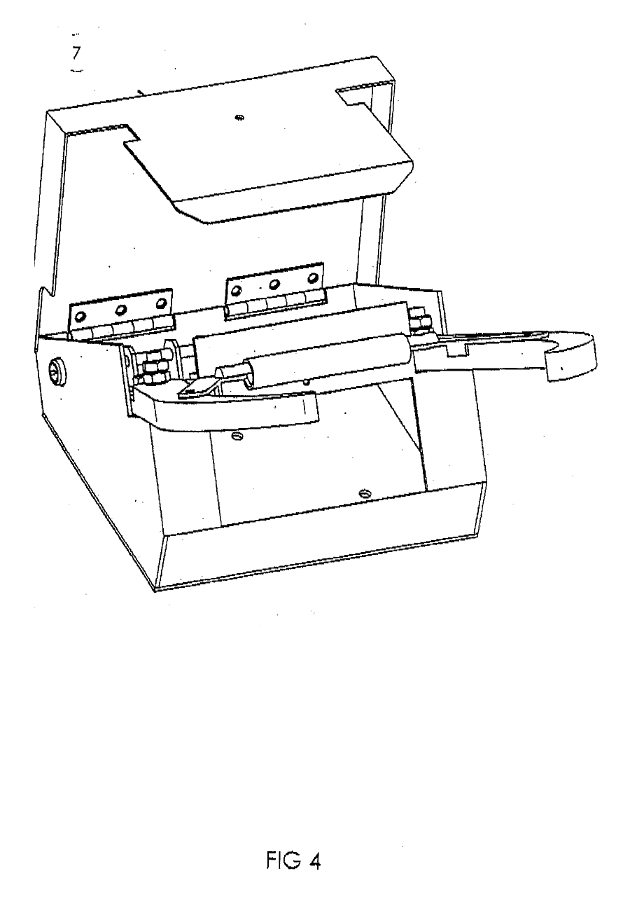

FIG. 5 is a perspective illustration of the device of FIG. 1 in a closed position with the lid also in a closed position.

### DETAILED DESCRIPTION OF THE INVENTION

A preferred embodiment of the invention will now be described with reference to the accompanying drawing figures.

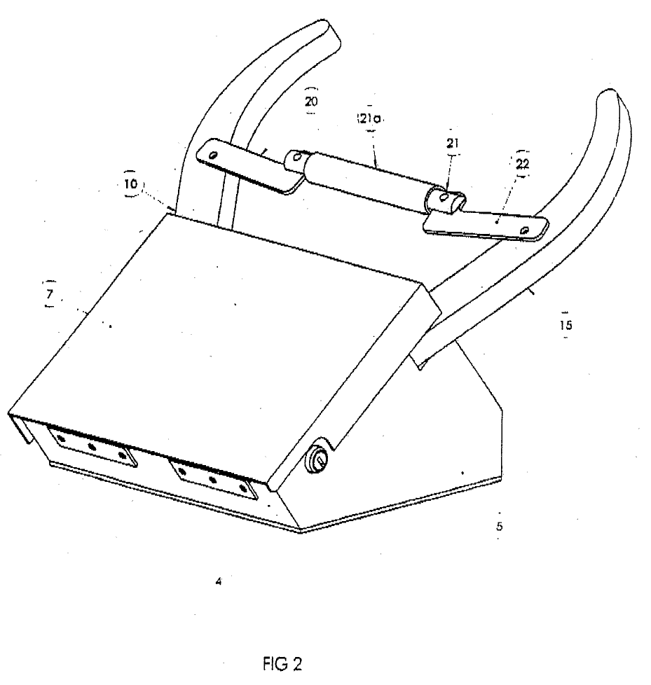

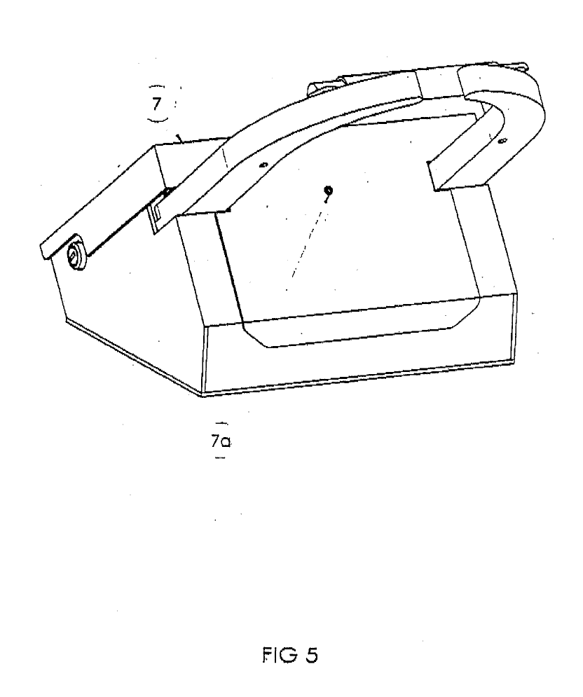

The locking device comprises a housing (1) having a base (2), a front face (3), an opposing rear face* (4), two opposing side faces (5,6) and a shaped hinged lid (7) (FIGS. 2 & 4), The lid (7) is hinged at the rear face (4) and is shaped to meet the front face (3) thus, when in the closed position (FIG. 5), covering the internals of the housing (1). A hold-down screw (7a) is used to secure the lid (7) in a closed position. The front face (3) includes two openings (8,9) at the intersection of the respective front face (3) with the side faces (5,6), A first arm (10) has one end (11) passing through the opening (8) and secured to the base (2) of the housing (1) by a pivot (12), The other end (13) of the arm (10) is essentially of arcuate configuration (14). A second arm (15) has one end (16) passing through the opening (9) and secured to the base (2) of the housing (1) by a pivot (17), The other end (18) of the arm (15) is essentially of arcuate configuration (19). The arms (10,15) are connected within the housing (1) with the respective arcuate portions (14,19) curving inwards. A linkage comprises three links (20,21,22); the first link (20) is essentially L-shaped with the head of the link connected by a pivot (23) to the first arm (10) approximately midway along that portion of the first arm (10) which is exposed from the housing (1), the foot of the link (20) being connected by a pivot (24) to the centre link (21); the other end of the centre link (21) is connected by a pivot (25) to the foot of the substantially L>>shaped link (22), the head of the link (22) being connected by a pivot (26) to the second arm (15) approximately midway along that portion of the arm (15) exposed from the housing (1). The centre link (21) is covered by a rolling sleeve (21a). The ends (11, 16) of the arms (10, 15) are connected by a series of pivotable links (27,28,29); a curved central link (28) is pivotally connected, to the base (2) of the housing (1) at approximately its mid-point (30); a first substantially linear link (27) is pivotally connected at one end (31) to the curved link (28) and at its other end (32) to the end (11) of the arm (10); a second substantially linear link (29) is pivotally connected at one end (33) to the other end of curved link (28) and at its other end (34) to the end (16) of the arm (15). A stop (35) extends upwards from the base (2) of the housing (1) sufficient for the end (11) of the arm (10) to abut thereto when the arms (10,15) are in an open position thus limiting the outward movement of the arms (10,15), A tension spring (36) is secured at on© end (37) to the base (2) of the housing (1) and at its other end (38) to the curved central link (28). A keyed pivoting locking mechanism (39) extending inwards from the side (5) of the housing (1) includes a bar (40) which, when the arms (10,15) are in a closed position can abut the curved central link (28) preventing movement of the link (38), and thus the arms (−10,15), to an open position.

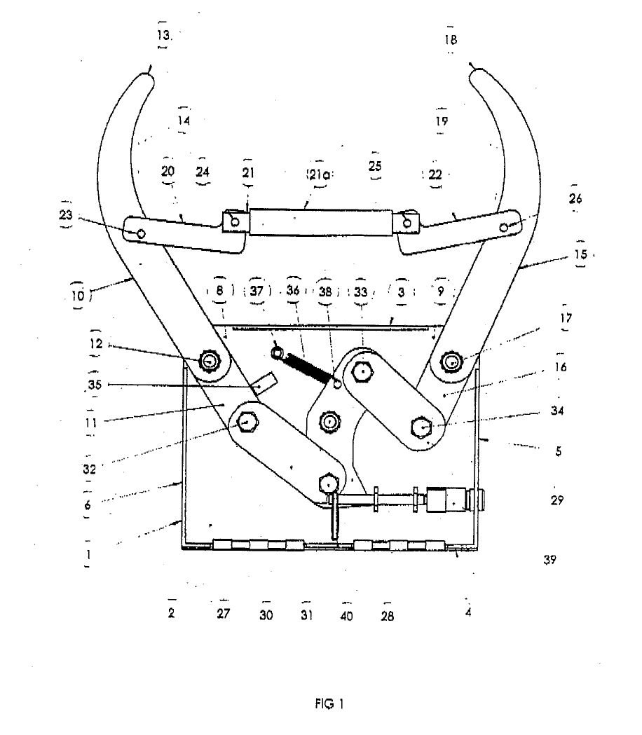

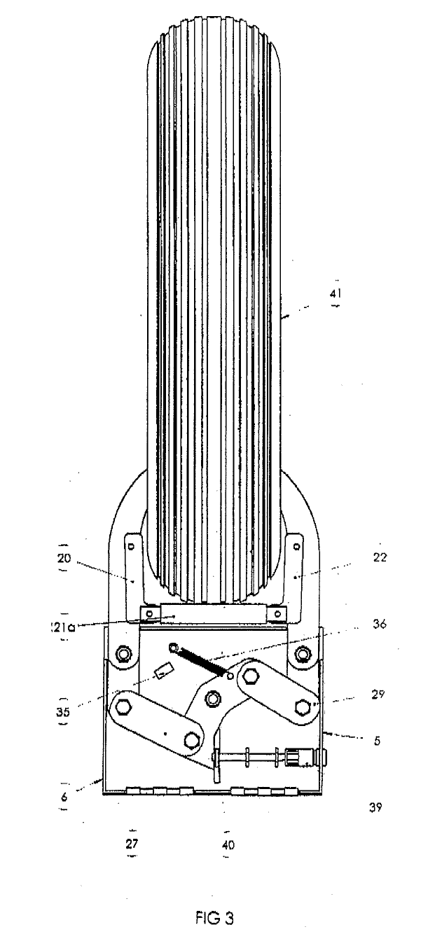

In use, the locking mechanism (39) is an unlocked position and the arms (10,15) are in an open position as illustrated in FIG. 1. The wheel (41) (FIG. 3) of a motor cycle is pushed against the rolling sleeve (21a) of the centre link (21) towards the front face (3) of the housing (1), the interconnecting links (20,22,27,28,29) thus assuming the closed position illustrated in FIG. 3 with the arcuate portions (14,19) of the arms (10,15) securely flanking the rim of the wheel (41), The locking mechanism (39) is then turned to the locked position and the key removed thus preventing movement of the arms (10,15) to any open position, In this closed position, the relative orientation of the arms (10, 15) to the leading face of the lid (7) substantially restricts movement of the lid (7), even if access to the hold-down screw (7a) is possible. To release the wheel (41), the locking mechanism (39) is first unlocked and the wheel (41) then moved in a direction away from the front face (3), the arms (10,15) thus being moved by the wheel (41) in an outwards direction, the spring (38) assisting the pivoting of the links (27,28,29) until movement of the end (11) of the arm (10) is arrested by the stop (35) and the arms (10,15) have thus again assumed the open position illustrated in FIG. 1.

The device of the present invention can be effectively permanently secured in position by, for example, securing the device to a plate which is bolted through to the ground. The heads of the bolts securing the device to the ground are only accessible when the lid (7) is open, such accessibility not being available when the device is in the locked position, thus adding to the overall security of the device. The device can thus be used in public places such as shopping centre car parks where multiple of such devices could be 5 present and users could rent the use of a key to unlock the device.

It will be appreciated that the above described embodiments are only exemplification of the various aspects of the present invention and that modifications and alterations can be made thereto, such as, the replacement of the manually keyed locking mechanism with an electrically or electronically l o operated locking mechanism and/or the inclusion of a lamp incorporated into the device for ease of use during low light conditions. Such modifications and alterations do not depart from the inventive concept as defined in the following claims.

1-18. (canceled)

19. A locking device for a vehicle that has at least one ground-engaging wheel, said device including:
a housing;
a first arm having one end pivotally connected within said housing and its opposing other end extending from said housing, said first arm adapted to pivot between a first open position and a second locked position;
a second arm substantially opposed to said first arm and having one end pivotally connected within said housing and its opposing other end extending from said housing, said second arm adapted to pivot between a first open position and a second locked position; and
a linkage external to said housing and pivotally connected between said first arm and said second arm;
wherein said first arm, said second arm and said linkage are adapted such that, upon sufficient forcible contact of said wheel with said linkage in a first direction substantially towards said housing, said first arm and said second arm can pivot from respective said first open position to respective said second locked position to flank and secure said wheel;
and wherein, upon subsequent sufficient forcible contact of said wheel at or near respective said other end of said first arm and/or said second arm in a second direction substantially opposed to said first direction, said first arm and said second arm can pivot from respective said second closed position to respective said first open position to release said wheel.

20. A device as defined in claim 1, which further includes a keyed locking mechanism to prevent said release of said wheel when secured by said first arm and said second arm by movement of said wheel in said second direction.

21. A device as defined in claim 1, which further includes an electrically or electronically operated locking mechanism to prevent said release of said wheel when secured by said first arm and said second arm by movement of said wheel in said second direction.

22. A device as defined in claim 1, wherein said locking mechanism is contained within said housing.

23. A device as defined in claim 1, wherein said housing is adapted to prevent unauthorized access to components therein.

24. A device as defined in claim 1, wherein said first arm and said second arm are each substantially arcuate in shape at or near said other end.

25. A device as defined in claim 1, wherein said linkage comprises a central link pivotally connected at each end to a respective outer link, the respective other end of each respective outer link being pivotally connected to respective said first arm and said second arm.

26. A device as defined in claim 1, wherein said one end of said first arm and said one end of said second arm are connected together by a series of pivotable links.

27. A device as defined in claim 1, wherein said device includes a stop within said housing to assist in locating said first arm and said second arm in said first open position.

28. A device as defined in claim 8, wherein said device includes a spring connected to one of said series of pivotable links to assist in locating said first arm and said second arm in said first open position.

29. A device as defined in claim 1, wherein said device is permanently secured to the ground.

30. A device as defined in claim 1, wherein said device incorporates a lamp for ease of use of said device during low light conditions.

31. A method to secure a vehicle that has at least one ground-engaging wheel, said method including use of a device as defined in claim 1.

32. A method as defined in claim 13, wherein two or more of said devices are deployed.

33. A method as defined in claim 14, wherein two or more of said devices are constructed as an integrated unit.

34. A method as defined in claim 14, wherein two of said devices are used to lock both wheels of a motor cycle.

35. A method as defined in claim 13, wherein two of said devices are used to lock at least two wheels of a four-wheeled motor vehicle.
